(19) United States
(12) Patent Application Publication
(10) Pub. No.: US 2006/0194020 A1
(43) Pub. Date: Aug. 31, 2006

(54) Electromagnetic shielding film for plasma display

(75) Inventors: Nobuo Naito, Tokyo-To (JP); Fumihiro Arakawa, Tokyo-To (JP); Tadahiro Masaki, Tokyo-To (JP)

Correspondence Address: OLIFF & BERRIDGE, PLC, P.O. BOX 19928, ALEXANDRIA, VA, 22320, US

(73) Assignee: DAI NIPPON PRINTING CO., LTD

(21) Appl. No.: 10/569,512

(22) PCT Filed: Aug. 26, 2004
(86) PCT No.: PCT/JP04/12293

§ 371 Date: Feb. 27, 2006

(30) Foreign Application Priority Data
Sep. 1, 2003 (JP) 2003308738

(51) Int. Cl. B32B 15/08; B32B 3/10

(52) U.S. Cl. 428/138; 428/457

(57) ABSTRACT

On one surface of a transparent substrate film 31 is provided directly or through an adhesive a metal layer 35 including a mesh work area 203 and a frame part 201 that surrounds the mesh work area 203. To the metal layer 35 are laminated a smoothing resin layer 39 and an adhesive layer 41. The transparent substrate film 31 side surface of the metal layer 35 is subjected to blackening treatment, thereby forming on this surface a blackening treatment layer 37. The smoothing resin layer 39 contains a near infrared rays absorbing agent, and the adhesive layer 41 contains a coloring agent for color tone correction that absorbs light with specific wavelengths originating from the emission spectrum of an insert gas.

### FIELD OF THE INVENTION

The present invention relates to an electromagnetic wave shielding film for a plasma display, and, more particularly, to an electromagnetic wave shielding film for a plasma display that is placed on the front of a plasma display element (also referred to as a PDP) so as to shield electromagnetic waves and near infrared rays that are emitted from the element and also to make an image displayed on a display (also referred to as an image display) highly visible.

### BACKGROUND ART

In this Specification, “ratio”, “part”, “%”, and the like indicating proportions are on a weight basis unless otherwise specified, and the symbol “/” denotes that layers enumerated together with it are integrally laminated. Further, “PDP” is an abbreviation for a “plasma display element”, and “NIR” indicates “near infrared rays”.

(Background of the Invention)

A PDP is composed of a glass substrate having a data electrode and a fluorescent layer and a glass substrate having a transparent electrode, a gas such as xenon or neon being sealed in a space between the two glass substrates. PDPs can be made large in screen size as compared with conventional cathode ray tubes (CRTs) and have come to be used widely. In operation, a PDP produces large amounts of electromagnetic waves, NIR, near infrared rays, and unwanted light with specific wavelengths originating from the emission spectrum of an insert gas. In order to shield or reduce these electromagnetic waves, NIR, and unwanted light with specific wavelengths, a front panel for a plasma display (composite filter) produced by laminating an electromagnetic wave shielding film, an NIR absorbing film, and an unwanted light absorbing film to a transparent substrate through an adhesive layer is mounted on the front of a PDP, whereby a plasma display is constructed. Such a front panel for a plasma display is required to have the property of shielding electromagnetic waves emitted from a PDP, especially to show a shielding efficiency of 30 dB or more at 30 MHz to 1 GHz. Further, NIR with wavelengths of 800 to 1,100 nm, emitted from a PDP, cause malfunction of remote controllers for VTRs and the like, so that the front panel is also required to shield these rays. Furthermore, it is also necessary to correct the inherent emission spectrum of an insert gas characteristic of a PDP, or to adjust the color tone of an image to a favorite one, thereby optimizing the color quality to improve image quality. The electromagnetic wave shielding film for a plasma display is required to have, in addition to moderate transparency (transparency to visible light, visible light transmittance) and luminance, various functions such as the function of imparting the property of preventing reflection of extraneous light and the anti-glare properties to a display so that an image displayed on the display can be seen with higher visibility. Moreover, it is required for the electromagnetic wave shielding film for a plasma display that the film, together with a substrate having mechanical strength high enough to prevent damage that is caused by external force, and other optional layers, can easily form a front panel for a plasma display.

(Prior Art)

A conventionally known front panel for a plasma display comprising an electromagnetic wave shielding film is a front panel that comprises an electromagnetic wave shielding adhesive film or a member using such a film and that shows excellent electromagnetic wave shielding properties when properly connected to an external electrode for grounding and has the property of shielding NIR and of transparency (see Patent Documents 1 to 3, for example). It is necessary that in the front panel disclosed in Japanese Laid-Open Patent Publication No. 15533/2003, a terminal area for grounding be formed by removing the upper layers of the front panel by a laser or the like, that in the front panel disclosed in Japanese Laid-Open Patent Publication No. 66854/2003, an edge part (terminal area) be formed by removing only one upper layer of the front panel, and that in the front panel disclosed in Japanese Laid-Open Patent Publication No. 324431/2002, an electrode (terminal area) be formed by the use of a silver base or a conductive tape. These conventional front panels are thus disadvantageous in that their production processes demand the additional terminal-area-forming step and also facilities and materials for use in this additional step, which leads to increase in costs.

There have also been known front panels for a plasma display that scarcely leak NIR (see Patent Documents 4 to 6, for example). In the front panel disclosed in Japanese Laid-Open Patent Publication No. 235115/2000, an NIR absorbing agent is incorporated in a substrate; in the front panel disclosed in Japanese Laid-Open Patent Publication No. 137442/2000, an NIR absorbing agent is incorporated in a substrate; and in the front panel disclosed in Japanese Laid-Open Patent Publication No. 186127/1998, an NIR absorbing agent is incorporated in a substrate or another layer. All of the above-described members in which an NIR absorbing agent is incorporated correspond to a transparent substrate in the present invention. These members are not easy to handle because they are large in size, are heavy, and are in sheet form. Moreover, they are ready-made, mass-produced materials, so that it is necessary that an NIR absorbing agent be specially incorporated in them in a separate step. These front panels are thus disadvantageous in that they have to be produced on a custom-made basis in a small quantity for each front panel type, resulting in increase in costs. Further, in general, NIR absorbing agents undergo deterioration by ultraviolet light and lose their ability to absorb NIR.

| Patent Document 1: | Japanese Laid-Open Patent Publication No. |
|---|---|
| | 15533/2003; |
| Patent Document 2: | Japanese Laid-Open Patent Publication No. |
| | 66854/2003; |
| Patent Document 3: | Japanese Laid-Open Patent Publication No. |
| | 324431/2002; |
| Patent Document 4: | Japanese Laid-Open Patent Publication No. |
| | 235115/2000; |
| Patent Document 5: | Japanese Laid-Open Patent Publication No. |
| | 137442/2000; and |
| Patent Document 6: | Japanese Laid-Open Patent Publication No. |
| | 186127/1998. |

### DISCLOSURE OF THE INVENTION

The present invention was accomplished in order to solve the aforementioned problems in the prior art. An object of the present invention is therefore to provide an electromagnetic wave shielding film for a plasma display having the properties of shielding electromagnetic waves, NIR, and unwanted light with specific wavelengths originating from the emission spectrum of an insert gas, being suited for small-quantity production of a variety of films.

The present invention is an electromagnetic wave shielding film for plasma display, comprising a transparent substrate film, a metal layer provided on one surface of the transparent substrate film either directly or through an adhesive, including a mesh part having a plurality of openings and a frame part surrounding the mesh part, and a smoothing resin layer and an adhesive layer that are successively laminated to the metal layer, the smoothing resin layer containing a near infrared rays absorbing agent, the adhesive layer containing a coloring agent for color tone correction that absorbs light with specific wavelengths originating from the emission spectrum of an insert gas of a plasma display.

The present invention is the above-described electromagnetic wave shielding film for plasma display, wherein the adhesive layer further contains a coloring agent for color tone adjustment useful in adjusting the color tone of an image displayed on a plasma display.

The present invention is the above-described electromagnetic wave shielding film for plasma display, wherein at least a part of the frame part of the metal layer is covered neither with the smoothing resin layer nor with the adhesive layer and is thus bare.

The present invention is the above-described electromagnetic wave shielding film for plasma display, further comprising an anti-reflection layer and/or an anti-glaring layer provided on the other surface of the transparent substrate film.

The present invention is the above-described electromagnetic wave shielding film for plasma display, wherein a blackening treatment layer is provided by blackening treatment on the transparent substrate film side surface of the metal layer.

The present invention is the above-described electromagnetic wave shielding film for plasma display, wherein the smoothing resin layer completely fills in the openings of the mesh part to form a smooth surface.

The present invention is the above-described electromagnetic wave shielding film for plasma display, wherein the smoothing resin layer fills in a part of the openings of the mesh part.

The present invention is the above-described electromagnetic wave shielding film for plasma display, wherein one or more of the layers provided between the transparent substrate film and the smoothing resin layer contain an ultraviolet light absorber.

According to the present invention, the metal layer is covered with the smoothing resin layer, and the concavities, especially the spaces around their corners, in the mesh part are filled with the smoothing resin layer, so that air bubbles are not generated when the pressure-sensitive adhesive layer is applied or laminated to the metal layer. A conventional front panel comprises no smoothing resin layer, and a pressure-sensitive adhesive layer is laminated directly to a metal layer, so that the deaeration step that is conducted, after lamination, under vacuum and/or pressure has been needed for removing air bubbles present around the corners of concavities in the mesh part of the metal layer. The present invention does not require this deaeration step. Further, a coloring agent for absorbing near infrared rays and a coloring agent for absorbing unwanted light with specific wavelengths originating from the emission spectrum of an insert gas are incorporated in different layers. Moreover, a coloring agent for color tone correction is incorporated in the pressure-sensitive adhesive layer in the final step; this manner is suitable for small-quantity production of a variety of products. There is therefore provided an electromagnetic wave shielding film for a plasma display in which it is easy to control only a coloring agent for color tone correction that requires the adjustment of transmittance according to the customer's preference per small-quantity lot for each film type and which can stably maintain image visibility for a long period of time.

According to the present invention, by incorporating a coloring agent for color tone adjustment in addition to the coloring agent for color tone correction, it is possible to adjust the color tone of a displayed image according to customer's preference.

According to the present invention, since the smoothing resin layer is applied pattern-wise so that a part of the frame part of the metal layer remains bare, it is possible to ground the front panel by the frame part without forming a terminal area. Furthermore, since the smoothing resin layer is applied pattern-wise only to a necessary part, reduction in material costs can be attained.

According to the present invention, since the electromagnetic wave shielding film has the property of preventing reflection of extraneous light and the anti-glare properties, it can prevent a display screen from mirroring extraneous light, resulting in improvement in image visibility.

According to the present invention, it is possible to further increase image contrast in the presence of extraneous light.

Moreover, according to the present invention, since an ultraviolet light absorber is incorporated in the layers provided between the transparent substrate film (extraneous light incident side) and the smoothing resin layer containing an NIR absorbing agent, it is possible to prevent the NIR absorbing agent from losing its ability to absorb NIR even when extraneous light containing ultraviolet light such as sunlight is incident on the electromagnetic wave shielding film.

### BRIEF DESCRIPTION OF THE DRAWINGS

FIG. 1 is a cross-sectional view of an electromagnetic wave shielding film for plasma display according to one embodiment of the present invention;

FIG. 2 is a plan view of an electromagnetic wave shielding film for plasma display according to one embodiment of the present invention; and

FIG. 3 is cross-sectional views of mesh parts of electromagnetic wave shielding films, showing particularly the relationship between the smoothing resin layer and the openings and line parts of the mesh part.

### BEST MODE FOR CARRYING OUT THE INVENTION

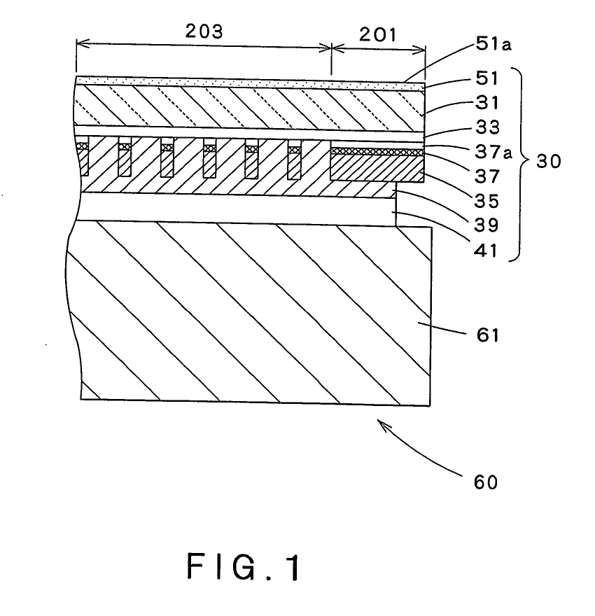

Embodiments of the present invention will be described hereinafter in detail with reference to the accompanying drawings. FIG. 1 is a cross-sectional view of an electromagnetic wave shielding film for plasma display, one embodiment of the present invention. FIG. 2 is a plan view of an electromagnetic wave shielding film for plasma display, one embodiment of the present invention.

(Basic Construction)

As shown in FIG. 1, an electromagnetic wave shielding film for plasma display 30 of the present invention comprises a transparent substrate film 31/an optional adhesive layer (adhesive) 33/a metal layer 35/a smoothing resin layer 39/an adhesive layer 41. Namely, the electromagnetic wave shielding film for plasma display 30 comprises the transparent substrate film 31, the metal layer 35 provided on one surface of the transparent substrate film 31 through the adhesive layer 33, and the smoothing resin layer 39 and the pressure-sensitive adhesive layer 41 that are successively provided on the metal layer 35.

The metal layer 35 includes a mesh work area (mesh part) 203 and a frame part 201 that surrounds the mesh work area 203. The surface of the metal layer 35 on the side of the transparent substrate film 31 is optionally subjected to blackening treatment, thereby forming a blackening treatment layer 37 on this surface. The smoothing resin layer 39 contains a near infrared rays absorbing agent, and the pressure-sensitive adhesive layer 41 contains a coloring agent for color tone correction that absorbs light with specific wavelengths originating from the emission spectrum of an insert gas. Further, as shown in FIG. 2, at least a part of the frame part of the metal layer 35 is not covered with the smoothing resin layer 39 and is thus bare. The pressure-sensitive adhesive layer 41 may contain a coloring agent for color tone adjustment in addition to the coloring agent for color tone correction. Furthermore, an anti-reflection layer and/or an anti-glaring layer 51 may be provided on the surface of the transparent substrate film 31 on the side opposite to the metal layer 35.

The electromagnetic wave shielding film for plasma display 30 of the present invention alone or combined with other members such as a protective plate serves as a front panel for plasma display when placed on the observation side of a PDP, and can show the required functions.

(Definitions of Coloring Agents)

Since a plurality of coloring agents is used in the present invention, they are, in this Specification, defined as follows in order to avoid confusion: a coloring agent for shielding near infrared rays with wavelengths of 800 to 1,100 nm, emitted from a PDP, is called “a near infrared rays absorbing agent (also referred to as an NIR absorbing agent)”; a coloring agent for absorbing the inherent emission spectrum of an insert gas (such as neon gas) characteristic of a PDP, that is, unwanted light with specific wavelengths, thereby correcting the color tone of an image to natural color is called “a coloring agent for color tone correction (also referred to as a Ne light absorbing agent when the coloring agent is for absorbing the emission spectrum of neon atom)”; and a coloring agent for adjusting the color tone of a displayed image to a favorite one is called “a coloring agent for color tone adjustment”.

(Production of and Materials for Electromagnetic Wave Shielding Film for Plasma Display)

An electromagnetic wave shielding film for plasma display of the present invention is produced in the following manner: (1) first, a metal layer 35 is prepared, and at least one surface of this layer is optionally subjected to blackening treatment; (2) the metal layer 35 or the blackening treatment layer 37 formed on the surface of the metal layer 35 and a transparent substrate film 31 are laminated to each other; (3) in the metal layer 35 laminated, a mesh work area 203 and a frame part 201 that surrounds the mesh work area 203 are formed photolithographically; (4) a smoothing resin layer 39 is formed pattern-wise so that it covers the mesh work area 203 in the metal layer 35 and that at least a part of the frame part 201 of the metal layer 35 remains bare; and (5) a pressure-sensitive adhesive layer 41 is formed on the surface of the smoothing resin layer 39. The production process and materials to be used will be described hereinafter.

(Metal Layer)

Materials capable of shielding electromagnetic waves, for example, metals such as gold, silver, copper, iron, nickel, chromium, and aluminum that have electrical conductivity good enough to fully shield electromagnetic waves, can be used for the metal layer 35. The metal layer may be a single layer of one metal or of an alloy, or composed of multiple layers. Examples of iron materials that are preferably used herein include low-carbon steels such as low-carbon rimmed steels and low-carbon aluminum killed steels, Ni—Fe alloys, and invar alloys. If cathodic electrodeposition is conducted for the blackening treatment, it is preferable to use copper or copper alloy foil as the metal layer because it is easy to conduct electrodeposition on such a material. Rolled or electrolytic copper foil may be used as the copper foil, and electrolytic copper foil is preferred because it is uniform in thickness, is highly adhesive to the blackening treatment layer and/or chromate treatment layer, and can have a thickness as small as below 10 μm. The thickness of the metal layer 35 is approximately from 1 to 100 μm, and preferably from 5 to 20 μm. When the metal layer 35 has a thickness of less than the above range, although it is easy to photolithographically make meshes in the metal layer 35, the metal layer 35 has an increased electrical resistance value and shows impaired electromagnetic wave shielding effect. When the metal layer 35 has a thickness of more than the above range, it is impossible to obtain the desired minute meshes, so that the substantial opening rate becomes low. Consequently, the light transmittance becomes lower and the viewing angle becomes narrower, resulting in lowering of image visibility.

The surface roughness of the metal layer 35, as indicated by Rz value, is preferably from 0.5 to 10 μm. When the metal layer 35 has a surface roughness value lower than this range, it reflects extraneous light by mirror reflection even if it has been subjected to the blackening treatment, and image visibility thus becomes lower. When the surface roughness value of the metal layer is in excess of the above range, an adhesive or resist does not spread, upon application, over the entire surface of the metal layer or involves air to form air bubbles. The surface roughness Rz is a ten-point mean roughness value obtained in accordance with JIS-B0601 (1994).

(Blackening Treatment)

Preferably, at least the surface of the metal layer 35 on the side of the transparent substrate film 31 is subjected to the blackening treatment, thereby forming, on this surface, a blackening treatment layer 37. Alternatively, blackening treatment layers 37 may be provided on both surfaces of the metal layer 35. The metal layer 35 in the form of a single layer is subjected to the blackening treatment and is then laminated to the transparent substrate film 31. After lamination, the surface of the bare metal layer 35 on the side opposite to the transparent substrate film 31 may also be subjected to the blackening treatment, thereby forming blackening treatment layers on both surfaces of the metal layer 35.

(Blackening of Both Surfaces)

The blackening treatment of both surfaces of the metal layer 35 may also be conducted in the following manner: the above-described metal layer 35 whose one surface has been subjected to the blackening treatment is laminated to a transparent substrate film 31 that will be described later; meshes are formed in the metal layer; and the other surface of the metal layer is then subjected to the blackening treatment. For the blackening treatment, those processes that will be described later can be employed, and plating is preferably used. If the blackening treatment is conducted after photolithographically forming the mesh part, both the surface (the surfaces of the line parts) and the side faces (the side faces of the line parts) of the mesh part of the metal layer are blackened. In this case, the mesh part shields electromagnetic waves emitted from a PDP, and the metallic wire part (line parts) for shielding electromagnetic waves does not reflect light. Consequently, a displayed image appears in an excellent state and can be viewed with high contrast.

The blackening treatment includes roughening (diffusion of incident light) and/or blackening (absorption of incident light) of the surface of the metal layer, and the deposition of a metal, an alloy, a metallic oxide, or a resin containing a black pigment (compound), or other various techniques may be employed for this treatment. Plating is preferably used for the blackening treatment, and by plating, there can be obtained a blackening treatment layer that is highly adhesive to the metal layer and can uniformly blacken the surface of the metal layer 35 with ease. At least one metal selected from copper, cobalt, nickel, zinc, tin, and chromium, or a chemical compound of these metals is used for plating. With other metals or compounds, the metal layer cannot be fully blackened, or the blackening treatment layer formed is poor in adhesion to the metal layer. Plating with cadmium is a typical example of such a case.

A process of plating that is preferably employed when copper foil is used as the metal layer 35 is cathodic electrodeposition plating in which copper foil is subjected to cathodic electrolysis in an electrolyte such as sulfuric acid, copper sulfate, or cobalt sulfate, thereby depositing cationic particles. The cationic particles deposited roughen the metal layer 35 to a higher degree, and, at the same time, blacken the metal layer. Although the cationic particles may be either copper particles or particles of an alloy of copper and another metal, copper-cobalt alloy particles are preferably used. The mean particle diameter of copper-cobalt alloy particles is preferably from 0.1 to 1 μm. By cathodic electrodeposition, it is possible to suitably deposit uniform particles with a mean particle diameter of 0.1 to 1 μm. If treated at high current density, the surface of copper foil becomes cathodic, generates reducing hydrogen, and is thus activated, so that there can be obtained significantly improved adhesion between the copper foil and the particles.

When copper-cobalt alloy particles with a mean particle diameter of more than the above range are deposited, the metal layer becomes thinner and processability becomes worse; for example, the metallic foil is broken in the step of laminating it to the substrate film. Moreover, the external appearance of the agglomerated particles becomes poor in denseness, and the non-uniformity of the external appearance and that of light absorption become noticeable. On the other hand, when the mean particle diameter is less than the above-described range, the copper-cobalt alloy particles cannot fully roughen the metal layer, which leads to decrease in image visibility.

It is also preferable to use black chromium or nickel for the blackening treatment because such a material is excellent in both electrical conductivity and blackness and its particles do not fall off. However, black nickel is sometimes poor in grounding characteristics. This disadvantage can be overcome by pattern-wise plating.

The color tone was indicated by the color system “L*, a *, b*, and ΔE*” according to JIS-Z8729 as the optical properties useful in evaluating the visibility of the electromagnetic wave shielding film 30. When the absolute values of “a*” and “b*” are smaller, the metal layer is more invisible, and the contrast is higher; as a result, higher image visibility is obtained.

In this Specification, roughening and blackening are collectively referred to as blackening treatment. The reflection value Y of the blackening treatment layer is preferably more than 0% and 20% or less. The reflection value Y was measured by a spectrophotometer UV-3100PC (manufactured by Shimadzu Corp., Japan), at an angle of incidence of 50 (wavelength: 380-780 nm).

(Anticorrosive Treatment)

An anticorrosive layer 37a may be optionally provided on the surface of the metal layer 35 and/or the blackening treatment layer 37, and it is preferable to provide the anticorrosive layer 37a at least on the blackening treatment layer 37. The anticorrosive layer 37a has the function of preventing the metal layer 35 and the blackening treatment layer 37 from corrosion, and also the function of, when particles have been deposited to form the blackening treatment layer, preventing falling or deformation of the particles. For the anticorrosive layer 37a, although conventional anticorrosive layers may be used, a layer of an oxide of nickel, zinc and/or copper, or a chromate treatment layer is suited. A conventional process of plating may be used to form a layer of an oxide of nickel, zinc and/or copper, and the thickness of the deposit layer is approximately from 0.001 to 1 μm, preferably from 0.001 to 0.1 μm.

(Chromate Treatment)

Chromate treatment is that a chromate treatment liquid is applied to an object to be treated. For the application of the chromate treatment liquid, a roll, curtain, squeeze, electrostatic spray, or dip coating method may be employed, for example. After application, the chromate treatment liquid applied is not washed away with water but is dried as it is. An aqueous solution containing 3 g/l of CrO₂ is usually used as the chromate treatment liquid. Specific examples of the chromate treatment liquid include Alsurf 1000 (trademark of a chromate treatment agent, manufactured by Nippon Paint Co., Ltd., Japan) and PM-284 (trademark of a chromate treatment agent, manufactured by Nippon Parkerizing Co., Ltd., Japan). The chromate treatment further enhances the effect of the blackening treatment.

(Transparent Substrate Film)

A variety of materials can be used for the transparent substrate film 31 as long as they have transparency, insulating properties, heat resistance, mechanical strength, and so on that are high enough to withstand service conditions and production. Examples of materials useful herein include polyester resins such as polyethylene terephthalate and polyethylene naphthalate; polyamide resins such as nylon 6 and nylon 610; polyolefin resins such as polypropylene and polymethyl pentene; vinyl resins such as polyvinyl chloride; acrylic resins such as polymethyl (meth)acrylate; engineering resins such as polyallylate, polysulfone, polyphenylene ether, and polyaramide; polycarbonate; styrene resins such as polystyrene; and cellulose resins such as triacetyl cellulose (TAC).

The transparent substrate film 31 may also be made from a copolymer resin or mixture (including an alloy) whose main components are resins selected from the above-enumerated ones, or may be a laminate of a plurality of layers. Although the transparent substrate film may be either an oriented or non-oriented film, a mono- or bi-axially oriented film is preferably used to obtain improved strength. The thickness of the transparent substrate film 31 is usually about 12 to 1000 μm, preferably 50 to 700 μm, and most preferably 100 to 500 μm. A transparent substrate film 31 with a thickness of less than the above range cannot have sufficiently high mechanical strength and unfavorably curls and slacks, while a transparent substrate film 31 with a thickness of more than the above range has excessively high strength, which is wasteful also from the viewpoint of cost. The transparent substrate film 31 may be a film, sheet, or board composed of at least one layer of any of the above-enumerated resins, and these forms are herein collectively referred to as films. In general, films of polyesters such as polyethylene terephthalate and polyethylene naphthalate are conveniently used for the transparent substrate film 31 because they are excellent in both transparency and heat resistance and are inexpensive, and, of these, polyethylene terephthalate is most preferred. With respect to the transparency of the transparent substrate film 31, the higher the better, and it is preferable that the transparent substrate film 31 has a visible light transmittance of not less than 80%.

The surface of the transparent substrate film 31 to be coated with an adhesive may be subjected to adhesion-improving treatment such as corona discharge treatment, plasma treatment, ozone treatment, flame treatment, primer (also referred to as anchoring agent, adhesion-promoting agent, or adhesion-improving agent) coating treatment, preheating, dusting, vacuum deposition, or alkali treatment. Additives such as fillers, plasticizers, and antistatic agents may also be incorporated in this transparent substrate film 31, as needed.

(Lamination)

The process of laminating the transparent substrate film 31 and the metal layer 35 is as follows: an adhesive (or pressure-sensitive adhesive) resin or an adhesive resin mixture is made into a latex, an aqueous dispersion, or an organic solvent solution, which is then printed on or applied to the surface of either the transparent substrate film 31 or the metal layer 35 by a conventional printing or coating method such as screen printing, gravure printing, comma coating, or roll coating, and is dried, if necessary, thereby forming an adhesive layer 33; the other member is superposed on this adhesive layer, and pressure is applied. The thickness of the adhesive layer is approximately from 0.1 to 20 μm (dry basis), preferably from 1 to 10 μm.

Usually used in the lamination process are continuous belt-shaped (rolled-up) materials. Specifically, the adhesive is applied to either the metal layer (metallic foil) or the transparent substrate film in the state of being unrolled from a wind-up roll and stretched, and is then dried; the other member is superposed on this adhesive layer, and pressure is applied. Further, aging (aging and hardening) is optionally conducted in an atmosphere at 300 to 80° C. for several hours to several days, thereby obtaining a laminate in the rolled-up state. Preferably used herein is a process that is called dry lamination by those skilled in the art. Furthermore, ionizing radiation curing resins that cure (react) in ionizing radiation such as ultraviolet rays (UV) and electron beams (EB) are preferably used. It is also possible to form the metal layer directly on one surface of the transparent substrate film by such a method as plating or vacuum deposition. In this case, no adhesive layer is used between the two members.

(Dry Lamination)

Dry lamination is a process for laminating two materials in the following manner: by a coating method such as roll, reverse roll, or gravure coating, an adhesive dispersed or dissolved in a solvent is applied to one material so that the applied layer has a thickness of 0.1 to 20 μm (dry basis), preferably 1.0 to 5.0 μm, and the solvent is evaporated, thereby forming an adhesive layer; immediately after the formation of the adhesive layer, the other laminating material is laminated to the adhesive layer; and this laminate is aged at 30 to 120° C. for several hours to several days, thereby hardening the adhesive. The adhesive layer that is used in the dry lamination process corresponds to the adhesive layer 33, and thermosetting adhesives or ionizing radiation curing adhesives can be used for this adhesive layer. Specific examples of thermosetting adhesives include two-part curing urethane adhesives that are obtained by the reaction of polyfunctional isocyanates such as tolylene diisocyanate or hexamethylene diisocyanate with hydroxyl-group-containing compounds such as polyether polyols or polyacrylate polyols; acrylic adhesives; and rubber adhesives. Of these, two-part curing urethane adhesives are preferred.

(Processing of Metal into Meshes)

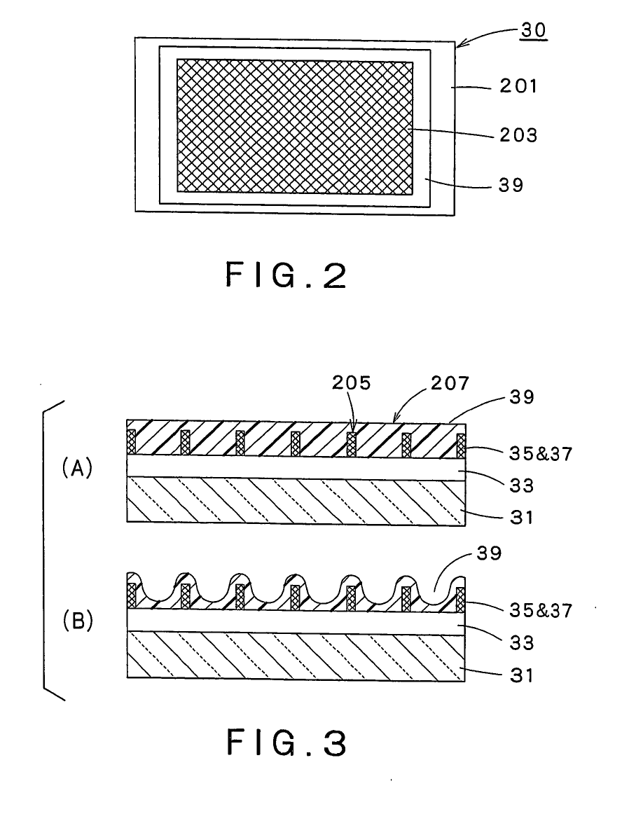

As shown in the plan view in FIG. 2, the metal layer 35 includes a mesh part 203 that is a mesh work area and a frame part 201 that surrounds the mesh part, is entirely made of the metal layer, and will serve as a terminal area. As shown in the cross-sectional view in FIG. 3, the mesh part 203 has a plurality of openings 207 that are surrounded by line parts 205, the remaining metal layer. The frame part 201, which is provided so that it surrounds the mesh part 203, is wholly the remaining metal layer and has no openings. To form the mesh work area, a conventional photolithographic process may be used.

(Photolithographic Process)

The metal surface of the laminate of the transparent substrate film 31/the adhesive layer 33/the metal layer 35 is photolithographically made into meshes. A resist layer is formed in a mesh pattern on this metal layer 35; those portions of the metal layer that are not covered with the resist layer are removed by etching; and then the resist layer is stripped, thereby obtaining a metal layer in the form of meshes. Also in this process, a belt-shaped laminate in the state of a continuously wind-up roll is processed. While transferring the laminate continuously or intermittently, masking, etching, and resist stripping are conducted with the laminate stretched and unslacked.

First, masking is conducted in the following manner: a photosensitive resist, for example, is applied to the entire surface of the metal layer and is dried; this metal layer is subjected to contact exposure, using an original plate (photomask) with a predetermined pattern (for making the line parts of the mesh part and the frame part); and the exposed metal layer is developed with water, subjected to film-hardening treatment, and baked. The resist is applied in the following manner: while continuously or intermittently transferring the belt-shaped laminate in the rolled-up state, a resist such as casein, PVA, or gelatin is applied to the metal layer surface of the laminate by such a method as dipping, curtain coating, or flow coating. Alternatively, a dry film resist may be used instead of coating a resist. The use of a dry film resist improves workability. Although baking is conducted at 200 to 300° C. when a casein resist is used, it is referable to make the baking temperature as low as possible in order to prevent the laminate from curling.

(Etching)

After the masking step, etching is conducted. In the case where etching is continuously conducted as in the present invention, it is preferable to use, as an etchant, an aqueous solution of ferric or cupric chloride that is easy to recycle. Further, the etching step is basically the same as the process of producing a shadow mask for a cathode ray tube of color TV; in this process, belt-shaped continuous steel stock, especially a thin plate with a thickness of 20 to 80 μm, is etched. Namely, the existing facilities for producing a shadow mask can be used, and a series of the steps of from masking to etching can be continuously effected, so that considerably high efficiency can be attained. After etching, the laminate is washed with water, subjected to resist stripping using an alkaline solution, cleaned, and then dried.

(Mesh)

The mesh part 203 is surrounded by the frame part 201 and has a plurality of openings 207 surrounded by the line parts 205. The opening 207 may be in any shape, for example, a triangle such as an equilateral triangle, a square such as a regular square, rectangular, rhombus or trapezoid, a polygon such as a hexagon, a circle, or an oval. The openings 207 of only one of, or two or more of the above types form the mesh part 203. From the viewpoint of the opening rate of the openings 207 and the invisibility of the meshes, it is preferable that the line width of the line parts 205 be 25 μm or less, more preferably 20 μm or less. From the viewpoint of light transmittance, it is preferable that the distance between the line parts 205 (line pitch) be 100 μm or more, more preferably 200 μm or more. In order to avoid the occurrence of moiré fringes or the like, the angle of bias between the line parts 205 and the borders of the electromagnetic wave shielding layer may be properly selected with consideration for the pixel and emission properties of a display.

FIGS. 3(A) and 3(B) are cross-sectional views of mesh parts of electromagnetic wave shielding films.

(Smoothing Resin Layer)

A smoothing resin layer 39 is provided on the surface of the metal layer or the blackening treatment layer 37 in the laminate of the transparent substrate film 31/the adhesive layer 33/the metal layer 35/the optional blackening treatment layer 37, laminated and being subject to the photolithographic process. After the mesh part 203 has been formed, although the frame part 201 and the line parts 205 of the mesh part 203 have a thickness equal to the thickness of the metallic foil, the openings 207 made by removing the metal layer 35 form cavities (concavities), and the mesh part 203 thus has irregularities. In the conventional art, an adhesive or pressure-sensitive adhesive is often applied in the subsequent step, and the concavities are filled with this adhesive or pressure-sensitive adhesive. However, the adhesive or pressure-sensitive adhesive fills in not all the corners of the concavities and includes air bubbles, which leads to decrease in transparency and image visibility. The step of deaeration that is effected under pressure or vacuum is therefore needed. This deaeration step is a batch process in which the laminate is placed in a closed container usually at a temperature between normal temperatures and about 70° C., and the container is pressurized and/or vacuumed, or repeatedly pressurized and vacuumed, for 30 to 60 minutes. Such a process is extremely low in productivity and demands high cost. Further, in the case where the laminate is attached, as it is, to a display after the formation of the mesh part 203, since the mesh part having irregularities is bare, the laminate is easily damaged and is poor in working characteristics. The present invention overcomes these shortcomings.

The smoothing resin layer 39 is applied so that it fills in the concavities in the openings 207 in the mesh part 203 and spreads to all the corners of the concavities, and that it protects the metal layer. A resin for the smoothing resin layer 39 is applied to the metal layer 35, thereby covering the metal layer 35 with the resin. As shown in FIG. 3(A), the surface of the metal layer 35 may be smoothed by filling the concavities in the openings 207 with the smoothing resin layer 39, and forming the smoothing resin layer 39 also on the metal layer 35. Alternatively, the surface of the smoothing resin layer 39 may not be smooth, as shown in FIG. 3(B), due to the concavities in the openings 207. In brief, what is essential for the smoothing resin layer 39 is that it covers both the concavities in the openings 207 and the metal layer 35 and spreads to all the corners of the concavities in the openings 207, thereby lessening the irregularities of the metal layer.

Any resin layer may be used for the smoothing resin layer 39 as long as it is highly transparent and highly adhesive to the metal of the mesh part and also to an adhesive that is used in the subsequent step. Any resin can be used for the smoothing resin layer 39 as long as it is transparent, and conventional thermoplastic resins, thermosetting resins, reactive resins, and ionizing radiation curing resins, and mixtures of these resins may be used. In the case where a thermosetting resin is used for the smoothing resin layer 39, if a coloring agent that will be described later, especially a diimmonium compound, is incorporated, the coloring agent undergoes change in the course of hardening reaction with a hardening agent having a functional group such as isocyanate group and tends to lose its function. Further, in the case where an ionizing radiation curing resin is used for the smoothing resin layer 39, the coloring agent can undergo color change or fading, or lose its function when ionizing radiation is applied. For this reason, it is preferable to use thermoplastic resins.

Also for isolating “a coloring agent for color tone correction” and/or “a coloring agent for color tone adjustment” that is incorporated in the pressure-sensitive adhesive layer 41, the use of a thermoplastic resin for the smoothing resin layer 39 is preferred, and the use of a high-polar synthetic resin having no functional group, or a synthetic resin having functional groups in a small number is more preferred.

Examples of thermoplastic resins useful herein include vinyl chloride resins such as vinyl chloride-vinyl acetate copolymers, vinyl chloride-vinyl alcohol acetate copolymers, and vinyl chloride-acrylonitrile copolymers; acrylic resins such as polymethyl (meth)acrylate resins, polybutyl (meth)acrylate resins, and acrylic ester-acrylonitrile copolymers; polyolefin resins such as cyclic polyolefins; styrene-acrylonitrile resins; polyvinyl butyral; polyester resins; polycarbonate resins; urethane resins; amide resins; cellulose resins (cellulose acetate butyrate, cellulose diacetate, cellulose triacetate, cellulose propionate, nitrocellulose, ethyl cellulose, methyl cellulose, propyl cellulose, methyl ethyl cellulose, carboxymethyl cellulose, acetyl cellulose, etc.); and mixtures of these resins. In this Specification, modified cellulose resins are also included in the synthetic resins.

Acrylic resins, acrylonitrile resins, urethane resins, and polyester resins are preferred as the thermoplastic resins. These thermoplastic resins are advantageous in that they satisfactorily dissolve and stably preserve dyes that serve as the coloring agents, and that the dyes dissolved in these resins can maintain their functions.

(Incorporation of Near Infrared Rays Absorbing Agent)

In the smoothing resin layer 39 is incorporated a near infrared rays absorbing agent (NIR absorbing agent). Any agent capable of absorbing near infrared rays to such a practical extent that the transmittance of the layer for near infrared rays with wavelengths of 800 to 1100 nm emitted from a PDP will be 20% or less, preferably 10% or less, can be used as the near infrared rays absorbing agent. Examples of the near infrared rays absorbing agent useful herein include near infrared rays absorbing dyes that show sharp absorption in the near infrared region and are highly transparent to light in the visible light range, such as polymethine dyes, cyanine compounds, phthalocyanine compounds, naphthalocyanine compounds, naphthoquinone compounds, anthraquinone compounds, dithiol metal complex compounds, immonium compounds, diimmonium compounds, and tungsten hexachloride.

The type and amounts of the coloring agents to be used may be properly selected depending on the absorption wavelengths and absorption coefficients of the coloring agents, the desired color tone, the transmittance required for the front panel for display, and so on. For example, the near infrared rays absorbing agent is incorporated in the layer in an amount of approximately 0.1 to 15% by weight of the layer, and the coloring agent for color tone correction or the coloring agent for color tone adjustment is incorporated in the layer in an amount of approximately 0.00001 to 2% by weight of the layer. In order to protect these coloring agents from ultraviolet light, a benzophenone or benzotriazole ultraviolet light absorber may be added to the layer. The amount of the ultraviolet light absorber to be added is approximately 0.1 to 10% by weight of the layer.

(Incorporation of Coloring Agent)

To incorporate, in the smoothing resin layer 39, a coloring agent consisting of the near infrared rays absorbing agent (NIR absorbing agent), an ink composition prepared by dissolving or dispersing a transparent synthetic resin and the coloring agent in a solvent is applied and dried. From the viewpoint of uniform dispersion of the coloring agent, it is preferable to prepare the ink composition in the following manner: the coloring agent is dissolved or dispersed in a solvent in advance; the transparent synthetic resin is also separately dissolved or dispersed in a solvent; and these two solutions or dispersions are blended or re-dispersed. Any method can be used for blending or dispersing the solutions or dispersions, and a conventional dispersion mixer such as a disper, mixer, tumbler, blender, homogenizer, or ball mill may be used.

(Formation of Smoothing Resin Layer)

To form the smoothing resin layer 39, the above-described resin is applied so that the concavities in the openings 207 are filled in with the resin. At this time, if the resin does not spread to all the corners of the concavities, the resin layer formed contains air bubbles and has decreased transparency. Therefore, by dissolving in a solvent or the like, the resin is made into a composition (ink) having a low viscosity, and this composition is applied and dried to form a layer. It is preferable from the viewpoint of uniform dispersion that the composition (ink) be prepared in the following manner; the above-described resin is dispersed or dissolved in a solvent such as methyl ethyl ketone, ethyl acetate and/or toluene; separately, the coloring agent is dispersed or dissolved in a similar solvent; and these dispersions or solutions are blended. The composition may be applied by a conventional printing or coating method such as screen printing, roll coating, reverse roll coating, slit reverse coating, spray coating, die coating, lip die coating, gravure coating (gravure printing), gravure reverse coating, or comma coating. If the composition does not spread to all the corners of the concavities, the composition layer applied contains air bubbles and has decreased transparency. Therefore, the composition is diluted with a solvent or the like, and the dilute composition with a low viscosity is applied and dried; or the composition is applied while conducting deaeration.

(Pattern-Wise Formation)

It is preferable that the smoothing resin layer 39 be applied pattern-wise, as shown in FIG. 2, and screen printing, gravure offset printing, or intermittent die coating is preferred as a method of pattern-wise application. The pattern is such that the smoothing resin layer applied covers the mesh part 203 but does not cover at least a part of the frame part 201 so that the metal layer 35, a part of the frame part 201, remains bare and can serve as a ground. The bare part may be the whole frame part 201, or one of, or two or more of the upper, lower, left-hand, and right-hand sides of the periphery of the mesh part 203, or a part of any one of these sides of the same. Since a part of the frame part 201 is bare, it is easy to connect the frame part 201 to the body of equipment, or the like for grounding. Further, the smoothing resin layer 39 is applied pattern-wise only to the necessary part, so that reduction in material costs can be attained. Furthermore, in the prior art, since a terminal area for grounding is not bare, a processing operation for making a bare terminal area has so far been separately conducted; however, in the present invention, such a processing operation is unnecessary because the smoothing resin layer is applied pattern-wise so that a part of the frame part remains bare.

(Pressure-Sensitive Adhesive Layer)

A pressure-sensitive adhesive layer 41 is provided on the surface of the smoothing resin layer 39 of the laminate of the transparent substrate film 31/the adhesive layer 33/the metal layer 35/the smoothing resin layer 39, laminated as described above. For the pressure-sensitive adhesive layer 41 can be used any conventional pressure-sensitive adhesive. Examples of pressure-sensitive adhesives useful herein include natural rubber; synthetic rubber resins such as butyl rubber, polyisoprene, polyisobutylene, polychloroprene, and styrene-butadiene copolymer resins; acrylic resins such as polymethyl (meth)acrylate, polybutyl (meth)acrylate, and methyl (meth)acrylate-butyl (meth)acrylate copolymer resins; vinyl acetate resins such as polyvinyl acetate and ethylene-vinyl acetate copolymers; urethane resins; acrylonitrile; hydrocarbon resins; alkylphenol resins; and rosin resins such as rosin, rosin triglyceride, and hydrogenated rosin. Preferred pressure-sensitive adhesives for the pressure-sensitive adhesive layer 41 are those materials having low chemical polarity and high transparency.

(Coloring Agent for Color Tone Correction)

PDPs generate the inherent emission spectrum light (unwanted light) of insert gases (e.g., neon, etc.) characteristic of PDPs to decrease the color purity of images. It is therefore necessary to provide a layer containing “a coloring agent for color tone correction (also referred to as a Ne light absorbing agent when the coloring agent is for absorbing the emission spectrum of neon atom)”, useful in shielding the emission spectrum light to correct the color purity. The “coloring agent for color tone correction” is incorporated in the pressure-sensitive adhesive layer 41. To absorb the emission spectrum of neon atom is used a coloring agent for color tone correction that shows the maximum absorption at a wavelength of 570 to 605 nm. Any conventional dye or pigment showing absorption at the desired wavelength in the visible light range is used as the coloring agent for color tone correction. Useful herein are conventional organic dyes such as anthraquinone, phthalocyanine, methine, azomethine, oxazine, azo, styryl, coumarin, porphyrin, dibenzofuranone, diketopyrrolopyrrole, rhodamine, xanthene, pyrromethene, and squarilium dyes.

(Coloring Agent for Color Tone Adjustment)

In addition to the “coloring agent for color tone correction”, a coloring agent for color tone adjustment may be incorporated in the pressure-sensitive adhesive layer 41. The coloring agent for color tone adjustment is used for improving transmission image contrast and for making color adjustment. Such a coloring agent absorbs visible light and is useful in varying the color tone of an image to adjust it to a favorite one. Examples of the coloring agent for color tone adjustment include organic or inorganic pigments such as monoazo pigments, quinacridone, thioindigo bordeaux, perylene maroon, aniline black, red oxide, chromium oxide, cobalt blue, ultramarine, and carbon black; and dyes such as indigoid dyes, carbonium dyes, quinoline dyes, nitroso dyes, naphthoquinone dyes, and perinone dyes. Coloring agents (dyes or pigments) preferred are rhodamine, porphyrin, cyanine, squarilium, azomethine, xanthene, oxonol, and azo compounds that show the maximum absorption at a wavelength of 560 to 620 nm; cyanine compounds, merocyanine compounds, oxonol compounds, methine compounds such as arylidene or styryl compounds, anthraquinone compounds, quinone compounds, diphenylmethane dyes, triphenylmethane dyes, xanthene dyes, azo compounds, and azomethine compounds that absorb light in a wave range of 380 to 440 nm; and cyanine, squarilium, azomethine, xanthene, oxonol, azo, anthraquinone, triphenylmethane, xanthene, copper phthalocyanine, phenothiazine, and phenoxazine compounds that absorb light in a wave range of 640 to 780 nm. These coloring agents may be used either singly or as a mixture.

The type and amounts of the coloring agents to be used may be properly selected depending on the absorption wavelengths and absorption coefficients of the coloring agents, the desired color tone, the transmittance required for the front panel for display, and so on. For example, the near infrared rays absorbing agent is incorporated in the layer in an amount of approximately 0.1 to 15% by weight of the layer, and the coloring agent for color tone correction or the coloring agent for color tone adjustment is incorporated in the layer in an amount of approximately 0.00001 to 2% by weight of the layer. In order to protect these coloring agents from ultraviolet light, a benzophenone or benzotriazole ultraviolet light absorber may be added to the layer. The amount of the ultraviolet light absorber to be added is approximately 0.1 to 10% by weight of the layer.

(Incorporation of Coloring Agents)

A manner in which at least one of the coloring agent for color tone correction (e.g., a Ne light absorbing agent) and the coloring agent for color tone adjustment is incorporated in the pressure-sensitive adhesive layer 41 may be that an ink composition prepared by dissolving or dispersing, in a solvent, a pressure-sensitive adhesive and a coloring agent for the pressure-sensitive adhesive layer 41 is applied and dried. From the viewpoint of uniform dispersion of the coloring agent, it is preferable to prepare the ink composition in the following manner: the coloring agent is dissolved or dispersed in a solvent in advance; the pressure-sensitive adhesive is also separately dissolved or dispersed in a solvent in advance; and these two solutions or dispersions are blended or re-dispersed. Any method can be used for blending or dispersing the solutions or dispersions, and a conventional dispersion mixer such as a disper, mixer, tumbler, blender, homogenizer, or ball mill may be used.

In the present invention, the near infrared rays absorbing agent (NIR absorbing agent) and the coloring agent for color tone correction (e.g., a Ne light absorbing agent) can be separately incorporated in the smoothing resin layer 39 and the pressure-sensitive adhesive layer 41, respectively. It is therefore possible to separately adjust the transmittances of the two coloring agents, so that it is easy to control the degree to which NIR and unwanted light are absorbed. Further, the coloring agent for color tone correction (e.g., a Ne light absorbing agent) and the coloring agent for color tone adjustment are incorporated in the pressure-sensitive adhesive layer 41 in the step close to the end of the whole process. For this reason, in the steps prior to this step of incorporating the coloring agents in the pressure-sensitive adhesive layer 41, it is possible to produce, in a large quantity according to one specifications, semi-finished products of one type for which the physical standard has been predetermined and which requires no color adjustment that has to be made while checking the transmission spectrum, so that they can be produced at low cost. Furthermore, the coloring agent for color tone correction and the coloring agent for color tone adjustment are incorporated in the step of forming the pressure-sensitive adhesive layer, or the final step, in which color tone correction and adjustment have to be made while checking the transmission spectrum. It is therefore possible to easily correct and adjust the color tone of an image according to customer's preference and to minimize the whole production time and the increase in cost. Moreover, since the step of forming the pressure-sensitive adhesive layer does not require high levels of processing accuracy and of processing condition control as compared with the step of forming the smoothing resin layer, it is suited for color tone correction or adjustment in small-quantity production of a variety of products.

(Release Paper)

Since the pressure-sensitive adhesive layer 41 has stickiness, it is preferable to lay release paper over the surface of the pressure-sensitive adhesive layer 41. If the electromagnetic wave shielding film is used right after the formation of the pressure-sensitive adhesive layer, this release paper is unnecessary. Useful herein for the release paper are conventional ones including polyethylene terephthalate films coated with silicone or melamine resins, and wood free paper. Further, instead of applying a pressure-sensitive adhesive to the smoothing resin layer 39, a pressure-sensitive adhesive film prepared by applying a pressure-sensitive adhesive to release paper may be laminated to the smoothing resin layer 39 surface of the laminate of the transparent substrate film 31/the adhesive layer 33/the metal layer 35/the smoothing resin layer 39. Preferably, the construction of the electromagnetic wave shielding film for plasma display 30 is the transparent substrate film 31/the adhesive layer 33/the metal layer 35/the smoothing resin layer 39 (containing the near infrared rays absorbing agent)/the pressure-sensitive adhesive layer 41 (containing the coloring agent for color tone correction, or both the coloring agent for color tone correction and the coloring agent for color tone adjustment)/the release paper, and the release paper is peeled off just before use.

(Anti-Reflection Layer And/Or Anti-Glaring Layer)

Thus, the function of shielding electromagnetic waves and near infrared rays has been imparted to one surface of the transparent substrate film 31. An anti-reflection layer and/or an anti-glaring layer 51 may further be provided on the other surface of the transparent substrate film 31. Although the anti-reflection layer and/or the anti-glaring layer 51 may be provided lastly, it is preferable that these layers be provided on the transparent substrate film 31 in advance.

(Function of Preventing Reflection)

In order to impart the function of preventing reflection to the surface of the above transparent substrate film 31, at least the anti-reflection layer and/or the anti-glaring layer 51 is provided on this surface. A commercially available transparent film having the function of preventing reflection, such as an anti-reflection film TAC-AR1 (trademark, manufactured by Dai Nippon Printing Co., Ltd., Japan), may be used as the anti-reflection layer. Owing to the function of preventing reflection, mirroring of extraneous light by the screen of a PDP, which is the reflection from the screen of extraneous light such as sunlight and light from fluorescent tubes incident on the screen, is reduced. Further, by controlling the reflectance of the surface, it is possible to make image contrast higher to improve image visibility.

(Anti-Reflection Layer)

In this Specification, an “anti-reflection layer” means one or more transparent dielectric layers laminated to the surface of the transparent substrate film 31. The dielectric layers are constructed so that the outermost layer in the dielectric layers has a refractive index lower than that of a layer existing right under the outermost layer (the transparent substrate film or a dielectric layer existing right under the outermost dielectric layer, or, when the anti-reflection layer is laminated to a hard coat layer as will be described later, the hard coat layer), and the optical thickness (refractive index×geometrical thickness) of each dielectric layer is made ¼ of the wavelength of light whose reflection should be prevented. The anti-reflection layer of such a construction can, by interference, attenuate light reflected from the layer-layer interfaces. Typical examples of the layer construction of the anti-reflection layer include (1) the transparent substrate film/(a low refractive index layer), (2) the transparent substrate film/(a high refractive index layer/a low refractive index layer), (3) the transparent substrate film/(a low refractive index layer/a high refractive index layer/a low refractive index layer), and (4) the transparent substrate film/(a high refractive index layer/a medium refractive index layer/a low refractive index layer).

In the above description, the parenthesized layers show the construction of the anti-reflection layer. As for materials for the constituent layers of the anti-reflection layer, materials for the low refractive index layer include inorganic materials such as magnesium fluoride (MgF₂) and rock crystal and low refractive index resin compositions that will be described later, and materials for the high refractive index layer include inorganic materials such as titanium dioxide and zinc sulfide. The anti-reflection layer may be formed by a conventional dry coating method such as vacuum deposition or sputtering, or a conventional wet coating method such as roll or lip die coating.

Specifically, it is possible to use (1) a laminate obtained by laminating, by vacuum deposition, a high refractive index layer with a refractive index of 2.3, made from zinc sulfide, and a low refractive index layer with a refractive index of 1.38, made from magnesium fluoride, in the order of (the transparent substrate film/[the high refractive index layer/the low refractive index layer/the high refractive index layer/the low refractive index layer]). The optical thickness of each layer is made 1/4 of the D line (approx. 590 nm) of the atomic spectrum of sodium with a wavelength around the center of the visible light range.

It is also possible to use (2) a laminate obtained by laminating a low refractive index layer to the surface of the transparent substrate film by applying a low refractive index resin composition by lip die coating. The optical thickness of the low refractive index layer is made ¼ of the D line (approx. 590 nm) of the atomic spectrum of sodium with a wavelength around the center of the visible light range. A composition prepared by dispersing transparent fine particles with a mean particle diameter of 5 to 300 nm in an ionizing radiation curing resin that contains fluorine atom in its molecule can be used as the low refractive index resin composition. When ionizing radiation is applied to cross-link and cure the low refractive index resin composition applied to the surface of the transparent substrate film, a large number of air-containing pores with a mean pore diameter of 0.01 to 100 nm are produced in the cured film and/or on the surface of the cured film, so that the cured film becomes porous. Thus, an ionizing radiation curing resin containing fluorine atom in its molecule has a low refractive index as compared with ordinary resins, and a film of such a resin is porous and contains air. Therefore, the mean refractive index of such a film approximates to the refractive index (1.0) of air, and, as a result, the film has a low refractive index. The ionizing radiation curing resin containing fluorine atom in its molecule is a polymer with a mean molecular weight of approximately 20,000 to 500,000, containing, in its molecule, an ionizing radiation curing functional group such as a radically polymerizable unsaturated group including (meth)acryloyl group or a cationically polymerizable functional group including epoxy group as an essential ingredient in addition to fluorine atom. (“(meth)acryloyl group” herein means “acryloyl group or methacryloyl group”.) Examples of the ionizing radiation curing resin containing fluorine atom in its molecule include homopolymers of monomers containing fluorine atom such as fluoroethylene, and copolymers of monomers containing fluorine atom and monomers containing no fluorine atom such as pentaerythritol triacrylate. To the polymer, a monomer containing three or more ionizing radiation curing functional groups in one molecule may further be added, as needed. This monomer may contain or may not contain fluorine atom. Electron beam, ultraviolet light, or the like is typically used as the ionizing radiation.

For the fine particles to be incorporated in the ionizing radiation curing resin are used hollow particles, porous particles, or the like that contain therein air. Even particles containing therein no air, such as particles that form fine air bubbles around them when dispersed in the ionizing radiation curing resin, or (primary) particles that conglomerate and agglomerate to involve air when dispersed in the ionizing radiation curing resin, may be used for the fine particles. Examples of the fine particles include hollow silica particles, porous silica particles, colloidal silica, and agglomerates of acrylic particles.

The amount of the fine particles to be added is approximately 1 to 400 parts by weight for 100 parts by weight of the ionizing radiation curing resin containing fluorine atom in its molecule.

(Hard Coat Layer)

A hard coat layer that is optionally provided between the transparent substrate film 31 and the anti-reflection layer 51 is composed of a layer having a pencil hardness of H or more as determined by pencil hardness tests according to JIS K5400. The hard coat layer is formed by applying one of polyfunctional (meth)acrylate prepolymers such as polyester (meth)acrylate, urethane (meth)acrylate, and epoxy (meth)acrylate, or polyfunctional (meth)acrylate monomers such as trimethylol propane tri(meth)acrylate and dipentaerythritol hexa(meth)acrylate, or a mixture of two or more of these prepolymers and monomers, and curing the applied film in heat or ionizing radiation.

(Anti-Glaring Layer)

In this Specification, an “anti-glaring layer” means a layer that diffuses (scatters) light by fine irregularities present on its surface, or by fine particles with different refractive indexes dispersed in it, thereby preventing glaring and flickering of an image displayed. As for the optical properties of the anti-glaring layer, the haze value is 3% or more, preferably 3 to 40%, more preferably 5 to 30%. An anti-glaring layer having a haze value of less than 3% is poor in anti-glaring properties, while an anti-glaring layer having a haze value in excess of 40% is poor in light transmittance. The 60 degree specular gloss is 100 or less, preferably 90 or less, more preferably 50 to 85. An anti-glaring layer having a 60 degree specular gloss of more than 100 is poor in anti-glaring properties because of surface gloss brought about by reflection. The transmission visibility is 100 or more, preferably 150 or more, more preferably 200 to 300. When the transmission visibility is less than 100, the image visibility is not sufficiently high. The total light transmittance of the anti-glaring layer is 70% or more, preferably 75% or more, more preferably 80 to 95%. An anti-glaring layer having a total light transmittance of less than 70% is poor in transparency. The above-described ranges are satisfactory when the anti-glaring properties, image visibility, light transmittance, transparency, and so on are totally taken into consideration.

(Anti-Staining Layer)

An anti-staining layer 51a may be provided on the surface of the anti-reflection layer and/or the anti-glaring layer 51. The anti-staining layer 51a is usually a water- and oil-repellent coat, and siloxane compounds, fluorinated alkylsilyl compounds, and the like may be used for this layer. Fluoroplastics or silicone resins that are used as water-repellent coatings are herein suitably used. For example, in the case where the low refractive index layer in the anti-reflection layer is made from SiO₂, it is preferable to use a fluorosilicate water-repellent coating.

(Ultraviolet Light Absorber)

In the electromagnetic wave shielding film 30 of the above-described construction, it is preferable to incorporate an ultraviolet light absorber in the layer (layers) provided between the substrate film 31 and the smoothing resin layer 39 containing the near infrared rays absorbing agent, in order to prevent deterioration of the near infrared rays absorbing agent by ultraviolet light contained in extraneous light such as sunlight. By doing so, ultraviolet light contained in extraneous light is absorbed and reduced before it reaches (the smoothing resin layer containing) the near infrared rays absorbing agent. The layer (layers) in which an ultraviolet light absorber is incorporated is one layer, or two or more layers, selected from the adhesive layer 33, the transparent substrate film 31, the anti-reflection layer and/or the anti-glaring layer 51, and the anti-staining layer 51a. Alternatively, a layer of a transparent resin containing an ultraviolet light absorber may be formed, separately from the above layers, in any position between the transparent substrate film 31 and the smoothing resin layer 39. For the ultraviolet light absorber is selected a transparent one, and examples of ultraviolet light absorbers useful herein include organic ultraviolet light absorbers such as benzotriazole compounds, benzophenone compounds, and triazine compounds, and inorganic ultraviolet light absorbers, such as zinc oxide and cerium oxide, composed of fine particles with a particle diameter of approximately 0.2 μm or less. The amount of the ultraviolet light absorber to be added is approximately 0.1 to 5% by weight of each layer.

(Production of Front Panel for Plasma Display)

Thus, there is obtained the electromagnetic wave shielding film for plasma display 30 of the present invention, and by using the electromagnetic wave shielding film 30 alone or by further laminating another transparent substrate 61 or the like to the electromagnetic wave shielding film 30, a front panel for plasma display 60 is obtained. In the case where release paper is used, after peeling off the release paper, the electromagnetic wave shielding film 30 is attached to the transparent substrate 61 through the pressure-sensitive adhesive layer 41. A glass plate or acrylic plate with a thickness of approximately 0.5 to 10 mm may be used as the transparent substrate 61.

(Assembly of Plasma Display)

Subsequently, the front panel for plasma display 60 is mounted on the front of a PDP, thereby obtaining a plasma display. At this time, the front panel for plasma display 60 is set so that the pressure-sensitive adhesive layer 41 or the transparent substrate 61 of the front panel faces to the PDP face. An air layer may be present between the front panel for plasma display 60 and the PDP, or these two members may be directly attached to each other with an adhesive or the like.

Since a part of the frame part 201 of the metal layer 35 on the observation side surface of the front panel for plasma display is bare, it is easy to ground the front panel by connecting the bare part to the body of the plasma display by a conventional conductive tape or the like. In a conventional front panel, the metal layer is not bare, so that there has been required the step of making the metal layer bare. According to the present invention, the plasma display is viewed from the side of the transparent substrate film 31, and the above-mentioned various functions and effects thereof are obtained.

(Modified Embodiment) (Formation of Metal Layer by Plating)

Although the metal layer 35 has been described hereinbefore as metallic foil, this metal layer may be obtained as meshes by plating. In this case, since the metal layer 35 is formed directly on one surface of the transparent substrate film 31 by plating, the adhesive layer 33 is unnecessary. The process of plating is as follows: a pattern consisting of a mesh part 203 existing at the center and a frame part 201 surrounding the mesh part is formed on one surface of the transparent substrate film 31, and this surface is subjected to treatment for making it electrically conductive, followed by blackening treatment; thereafter, the surface is plated with a metal having the function of shielding electromagnetic waves. The mesh work area 203 and the frame part 201 surrounding the mesh work area 203 can be obtained by forming the desired mesh pattern when conducting the treatment for making mesh-wise the surface electrically conductive. Thus, there is obtained the metal layer 35, in which the mesh work area 203 and the frame part 201 surrounding the mesh work area 203 have been simultaneously formed. An anticorrosive layer is optionally formed on the metal layer 35. The materials that are used for forming the transparent substrate film 31, the metal layer 35, and the blackening treatment layer 37 in the plating process are the same as the materials used for forming these layers in the photolithographic process. The difference between the plating process and the photolithographic process is only a manner in which the metal layer is formed.

### EXAMPLES

The present invention will now be explained more specifically by way of Examples and Comparative Examples. However, the present invention is not limited by these Examples.

### Example 1

(Metal Layer, Blackening Treatment Layer)

Electrolytic copper foil with a thickness of 10 μm was used as the metal layer. Copper-cobalt alloy particles (mean particle diameter: 0.3 μm) were cathodically electrodeposited on one surface of the metal layer, thereby forming on this surface a blackening treatment layer.

(Substrate Film and Lamination)

The blackening treatment layer and a biaxially oriented PET film A4300 (trademark, polyethylene terephthalate manufactured by Toyobo Co., Ltd., Japan) with a thickness of 100 μm were laminated with a two-part curing urethane adhesive, and this was aged at 50° C. for 3 days, thereby obtaining a laminate. For the adhesive, polyester urethane polyol was used as the main agent, and hexamethylene diisocyanate was used as the curing agent. The adhesive was applied in such an amount that the dry adhesive layer had a thickness of 4 μm.

(Formation of Mesh Part)

A mesh part was photolithographically formed in the copper foil in the laminate. Using the existing production line for shadow masks for color TV, the laminate in the form of a belt-shaped (rolled-up) continuous web was subjected to a series of the steps of from masking to etching. First, a casein resist was applied to the entire surface of the copper layer in the laminate by flow coating. This laminate was intermittently transferred to the next station, where contact exposure was conducted by the use of an original plate with a negative pattern for forming a mesh part 203 having square openings 207 and line parts 205 with a line width of 22 μm, a line distance (pitch) of 300 μm, and an angle of bias of 49 degrees, and a frame part 201 with a width of 15 mm, surrounding the mesh part. The exposed laminate was then transferred from one station to another for development with water, for film-hardening treatment, and for baking by heating. The baked laminate was further transferred to the next station, where etching was conducted by spraying, as an etchant, an aqueous ferric chloride solution over the laminate, thereby making openings 207. This laminate was then transferred from one station to another for washing with water, for resist stripping, for cleaning, and for drying by heating, thereby forming the mesh part 203.

(Formation of Smoothing Resin Layer)

Subsequently, a smoothing resin layer 39 was formed. A composition liquid for forming the smoothing resin layer was prepared by blending, with an acrylic resin, the following coloring agent dispersed or dissolved in methyl ethyl ketone.

(Coloring Agent)

For the coloring agent was used a mixture of a diimmonium colorant CIR1085 (trademark, manufactured by Japan Carlit, Co., Ltd., Japan), a phthalocyanine dye IR12 (trademark, manufactured by Nippon Shokubai Co., Ltd., Japan), and a phthalocyanine dye IR14 (trademark, manufactured by Nippon Shokubai Co., Ltd., Japan), serving as the near infrared rays absorbing agent (NIR absorbing agent).

The above-described composition liquid for forming the smoothing resin layer was applied pattern-wise only to the mesh part by die coating and was dried, thereby obtaining the mesh part 203 covered with the smoothing resin layer and the smoothing resin layer 39 (15 μm thick when dried) formed on the bare frame part 201 (metal layer) with a width of 15 mm.

(Pressure-Sensitive Adhesive Layer)

The following composition for forming a pressure-sensitive adhesive layer was printed only on the mesh part 203 by a screen printing method and was dried. To this was laminated a 75-μm thick PET separator coated with silicone. Thus, there was obtained an electromagnetic wave shielding film for plasma display 30 of Example 1, including the mesh part 203 covered with the pressure-sensitive adhesive layer 41 and the bare frame part (metal layer) 201 with a width of 15 mm.

(Composition for Forming Pressure-Sensitive Adhesive Layer)

A composition prepared by incorporating, in an acrylic resin pressure-sensitive adhesive, TAP-2 (trademark, manufactured by Yamada Chemical Co., Ltd., Japan) serving as the coloring agent for color tone correction (Ne light absorbing agent) was used as the above-described composition for forming a pressure-sensitive adhesive layer.

### Example 2

(Containing Coloring Agent for Color Tone Adjustment)

An electromagnetic wave shielding film for plasma display 30 was obtained in the same manner as in Example 1, except that PS Violet RC (trademark, manufactured by Mitsui Toatsu Dyes, Ltd., Japan) was further added, as the coloring agent for color tone adjustment, to the composition liquid for forming the pressure-sensitive adhesive layer 41.

### Example 3

An electromagnetic wave shielding film for plasma display 30 was obtained in the same manner as in Example 1, except that an anti-reflection film TAC-AR1 (trademark of an anti-reflection film, manufactured by Dai Nippon Printing Co., Ltd., Japan) (layer construction: an 80-μm thick TAC (triacetyl cellulose) film/a hard coat layer/a low refractive index layer/an anti-staining layer) was used as the transparent substrate film and that the metal layer was laminated to the non-anti-reflection surface of this transparent substrate film.

### Example 4

(Containing Ultraviolet Light Absorber)

An electromagnetic wave shielding film for plasma display 30 was obtained in the same manner as in Example 1, except that a biaxially oriented film with a total thickness of 100 μm, consisting of a two-layered laminate of a polyethylene terephthalate layer with a thickness of 80 μm, containing, as an ultraviolet light absorber, 1% by weight of 2(4,6-diphenyl-1,3,5-triazine-2-yl)-5-[(hexyl)oxy]-phenol, and a polyethylene terephthalate layer with a thickness of 20 μm, containing no ultraviolet light absorber was used as the transparent substrate film, and that the metal layer was laminated to the transparent substrate film with the blackening treatment layer on the former facing to the layer containing no ultraviolet light absorber, contained in the latter.

### Referential Examples 1 to 4

Each of the electromagnetic wave shielding films for plasma display 30 of Examples 1 to 4 was attached to an acrylic resin plate with a thickness of 5 mm through the pressure-sensitive adhesive layer in the former, thereby obtaining a front panel for plasma display. Each of these front panels for plasma display was mounted on the front of a PDP “WOOO” (trademark, manufactured by Hitachi Ltd., Japan) through a 5-mm thick air layer, thereby obtaining a plasma display.

### Referential Example 5

The front panel for plasma display of Referential Example 1 was attached directly to the front of a PDP “WOOO” (trademark, manufactured by Hitachi Ltd., Japan) with an acrylic resin pressure-sensitive adhesive, thereby obtaining a plasma display.

(Evaluation)

The electromagnetic wave shielding films were evaluated in terms of the property of shielding electromagnetic waves, the property of absorbing near infrared rays, as well as the color tone of an image, the fading of the coloring agents after resistance-to-moist-heat tests and light fastness tests, image visibility, and the fading of an image and the decrease in the property of absorbing near infrared rays after the light fastness tests. The color tone of an image was evaluated by visually observing the color tone of a TV test pattern displayed, and the electromagnetic wave shielding film that showed no abnormality was judged to be acceptable. The fading of the coloring agents was evaluated by visually observing the color of the electromagnetic wave shielding film before and after resistance-to-moist-heat tests (preserved in an atmosphere of 60° C. and 95% RH for 1000 hours) and light fastness tests (exposed to light for 100 hours in a sunshine carbon arc fadeometer at a black panel temperature of 63° C.). The electromagnetic wave shielding film that underwent no significant change in color was judged to be acceptable. Image visibility was evaluated by visually observing the color tone of a black-and-white image displayed, and the electromagnetic wave shielding film that caused neither glaring nor remarkable mirroring of extraneous light was judged to be acceptable. As for the property of absorbing near infrared rays and the decrease in this property after the light fastness tests, the transmittance for light in a wave range of 800 to 1100 nm was determined before and after the light fastness tests, and the electromagnetic wave shielding film that showed a transmittance of 10% or less for light with wavelengths in the above wave range was judged to be acceptable. Further, the property of shielding electromagnetic waves was evaluated by measuring electromagnetic waves using the KEC method (a method of measurement developed by Kansai Electronic Industry Development Center, Japan). The electromagnetic wave shielding film that attenuated electromagnetic waves at a rate of 30 dB or more at frequencies of 30 MHz to 1 GHz was judged to be acceptable.

(Results of Evaluation)

In terms of the property of shielding electromagnetic waves, and the property of absorbing near infrared rays before the resistance-to-moist-heat tests and the light fastness tests, the electromagnetic wave shielding films of all Examples and the front panels of all Referential Examples were judged to be acceptable. Further, the electromagnetic wave shielding films of Examples 1 to 3 were judged to be acceptable in terms of the color tone of an image, the fading of the coloring agents after the resistance-to-moist-heat tests, and image visibility. However, they were judged to be unacceptable in terms of the fading of the coloring agents after the light fastness tests because yellowing was observed. Furthermore, with respect to the property of absorbing near infrared rays after the light fastness tests, they had transmittances of more than 10% for near infrared rays in the above-described wave range, so that they were judged to be unacceptable.

On the other hand, the electromagnetic wave shielding film of Example 4 was judged to be acceptable in terms of the fading of the coloring agents after the light fastness tests and the property of absorbing near infrared rays after the light fastness tests. The front panels of Referential Examples 1 to 5 were judged to be acceptable in terms of both the color tone of an image and image visibility.

1. An electromagnetic wave shielding film for plasma display, comprising:
a transparent substrate film,
a metal layer provided on one surface of the transparent substrate film either directly or through an adhesive, including a mesh part having a plurality of openings and a frame part surrounding the mesh part, and
a smoothing resin layer and an adhesive layer that are successively laminated to the metal layer,
the smoothing resin layer containing a near infrared rays absorbing agent,
the adhesive layer containing a coloring agent for color tone correction that absorbs light with specific wavelengths originating from the emission spectrum of an insert gas of a plasma display.

2. The electromagnetic wave shielding film for plasma display according to claim 1, wherein
the adhesive layer further contains a coloring agent for color tone adjustment for adjusting the color tone of an image displayed on a plasma display.

3. The electromagnetic wave shielding film for plasma display according to claim 1, wherein
at least a part of the frame part of the metal layer is covered neither with the smoothing resin layer nor with the adhesive layer and is thus bare.

4. The electromagnetic wave shielding film for plasma display according to claim 1, further comprising:
an anti-reflection layer and/or an anti-glaring layer provided on the other surface of the transparent substrate film.

5. The electromagnetic wave shielding film for plasma display according to claim 1, wherein
a blackening treatment layer is provided by blackening treatment on the transparent substrate film side surface of the metal layer.

6. The electromagnetic wave shielding film for plasma display according to claim 1, wherein
the smoothing resin layer completely fills in the openings of the mesh part to form a smooth surface.

7. The electromagnetic wave shielding film for plasma display according to claim 1, wherein
the smoothing resin layer fills in a part of the openings of the mesh part.

8. The electromagnetic wave shielding film for plasma display according to claim 1, wherein
one or more of the layers provided between the transparent substrate film and the smoothing resin layer contain an ultraviolet light absorber.

9. The electromagnetic wave shielding film for plasma display according to claim 2, wherein
one or more of the layers provided between the transparent substrate film and the smoothing resin layer contain an ultraviolet light absorber.

10. The electromagnetic wave shielding film for plasma display according to claim 3, wherein
one or more of the layers provided between the transparent substrate film and the smoothing resin layer contain an ultraviolet light absorber.

11. The electromagnetic wave shielding film for plasma display according to claim 4, wherein
one or more of the layers provided between the transparent substrate film and the smoothing resin layer contain an ultraviolet light absorber.

12. The electromagnetic wave shielding film for plasma display according to claim 5, wherein
one or more of the layers provided between the transparent substrate film and the smoothing resin layer contain an ultraviolet light absorber.

13. The electromagnetic wave shielding film for plasma display according to claim 6, wherein
one or more of the layers provided between the transparent substrate film and the smoothing resin layer contain an ultraviolet light absorber.

14. The electromagnetic wave shielding film for plasma display according to claim 7, wherein
one or more of the layers provided between the transparent substrate film and the smoothing resin layer contain an ultraviolet light absorber.
